(19) United States
(12) Patent Application Publication
(10) Pub. No.: US 2015/0177199 A1
(43) Pub. Date: Jun. 25, 2015

(54) METHOD AND APPARATUS FOR CHARACTERIZING IMPURITY PROFILE OF ORGANIC MATERIALS

(71) Applicants: János Borbély, Debrecen (HU); Krisztián Gábor Torma, Balkany (HU); Erika Fazekas, Miskolc (HU)

(72) Inventors: János Borbély, Debrecen (HU); Krisztián Gábor Torma, Balkany (HU); Erika Fazekas, Miskolc (HU)

(73) Assignee: BBS Nanotechnology Ltd., Debrecen (HU)

(21) Appl. No.: 14/576,319

(22) Filed: Dec. 19, 2014

Related U.S. Application Data
(60) Provisional application No. 61/917,986, filed on Dec. 19, 2013.

(51) Int. Cl. G01N 30/06; G01N 30/74

(52) U.S. Cl. CPC G01N 30/06; G01N 30/74

(57) ABSTRACT

Method and apparatus for characterizing drug-modified polymers, macromolecules, proteins, antigens, antibodies or nanoparticles and quantitative determination of their impurity profile by two-dimensional liquid chromatography analysis. The first dimension is preferably size exclusion chromatography (SEC)—which is also known as gel permeation chromatography in case of non-aqueous samples (GPC)—for complete molecular weight analysis of nanoscale particles. It is not just included the application of separating small molecules from big molecules, but it is also the separation of different sorts of oligomers (e.g. monomers, dimers, trimers, tetramers). The second dimension is adapted for separating and characterizing small molecules which can be impurities or non-reacted modifiers with high-performance liquid chromatography (HPLC). Between the dimensions it is feasible to use solid phase extraction column(s) to collect small molecules, wash off or change solvent, or minimize broadening of their peaks.

This application claims priority to provisional application No. 61/917,986, filed Dec. 19, 2013, which is hereby incorporated by reference herein.

### FIELD OF THE INVENTION

Method and apparatus for characterizing drug-modified polymers, macromolecules, proteins, antigens, antibodies or nanoparticles and quantitative determination of their impurity profile by two-dimensional liquid chromatography analysis. The first dimension is preferably size exclusion chromatography (SEC)—which is also known as gel permeation chromatography in case of non-aqueous samples (GPC)—for complete molecular weight analysis of nanoscale particles. It is not just included the application of separating small molecules from big molecules, but it is also the separation of different sorts of oligomers (e.g. monomers, dimers, trimers, tetramers). The second dimension is adapted for separating and characterizing small molecules which can be impurities or non-reacted modifiers with high-performance liquid chromatography (HPLC). Between the dimensions it is feasible to use solid phase extraction column(s) to collect small molecules, wash off or change solvent, or minimize broadening of their peaks.

The advantage of this system is that it allows separating small molecules from polymers, macromolecules, proteins, antigens, antibodies or nanoparticles, and their average molecular weight and particle size distribution can also be determined. Since the separation of small molecules from the big molecules occurred, it is possible to drive the small molecules to an HPLC column, where their separation and quantitative determination can be done. In this system SPE (Solid Phase Extraction) column is capable of using right after the size exclusion separation to defend SEC column from high pressure, which can be generated by the HPLC column.

### BACKGROUND OF INVENTION

The total analysis of different sorts of polymers, macromolecules, proteins, antigens, antibodies or any kind of nanoparticles are highly important not only in case of pharmaceutical products, but also in industrial processes. The size exclusion chromatography was invented with the aim to allow separating molecules based on their molecular sizes/shapes. The SEC columns contain highly porous material, silica or synthetic polymer. The separation of compounds is based on the amount of time that molecules spend in the pores of beads of column. The big molecules cannot enter the pores—they are excluded—so they move only in the interparticle space while the small molecules can penetrate more region of the pore system. Because of the exclusion, big molecules elute first and small molecules come later off the column. Unfortunately, this technique is not able to separate small molecules from each other, they elute from the column usually under one peak if the differences between their mass are not bigger than 2-3 kDa. To separate and quantitatively analyze these molecules high performance liquid chromatography should be used.

The idea of the coupled LC-LC systems is developed since the early 80s, so it is not surprising that many publications can be found in the literature about it. Also many examples can be found in the literature to couple size exclusion chromatography with high performance liquid chromatography. There is a widely used method when firstly the separation of small molecules from the polymers, proteins is carried out with SEC and then they collect predefined volumes of elute as fractions immediately after the column. Samples from these fractions are analyzed by HPLC technique. It is not just a complicated method, but it requires a lot of extra time. Besides, it has to be mentioned that it is technically impossible to fully automate these systems.

Despite the fact that the coupling of size exclusion chromatography with high-pressure liquid chromatography has huge benefits, very few articles can be found in the literature where they are exist in an automated system.

Although the systems and methods have proven to be useful for separation and characterization of polymers, they generally encounter with inefficiencies (e.g., complicated control of system, all dimensions have individual detectors for the same purpose).

Therefore, there are remaining needs in the literature for improved methods and systems for characterizing modified polymers, macromolecules, proteins, antigens, antibodies or nanoparticles by two-dimensional liquid chromatography.

### SUMMARY OF INVENTION

The present invention relates to an easy method and comprehensive apparatus that allow characterization of characterization of nanoscale particles and for quantitative determination of their impurity profile.

Briefly, this invention is based on an HPLC system which contains two individually working switching valves. Although, valves can operate separately, to ensure the total analysis both are necessary. The first switching valve manages switching between columns (SEC column, HPLC column, and SPE column or SPE-HPLC columns). The second one is responsible for the detectors and for forming connections between columns.

This comprehensive two-dimension liquid chromatography system is designed for the complete characterization of nanoscale particles and for the quantitative determination of their impurity loading/small molecule content. The two-dimension liquid chromatography system allows the further separation of molecules with small M_{w} in the second dimension after they have been separated from nanoscale particles in the first dimension.

Further, the first and the second dimensions of two-dimension liquid chromatography system could be directly-coupled or connected indirectly through a SPE column. In case of the former the components separated in the first dimension and the defined volume of elute drained toward the second dimension using a two-position, ten-port switching valve. The method almost the same in case of latter, but the desired volume of elute pass through a SPE column, where the components in that are adsorbed on the solid phase extraction material. It is feasible to use a two-position, ten-port switching valve. The components can be washed off from the SPE column with intensifying solvent gradient and can be drained toward the second dimension using another two-position, ten-port switching valve.

### BRIEF DESCRIPTION OF THE DRAWINGS

FIG. 1 is a schematic representation of a two-dimensional liquid chromatography system.

FIG. 2 is a graphical representation of a two-dimensional liquid chromatography system with great emphasis on connectors, detectors, columns and valves.

FIG. 3 shows the flow path when both valves in Position A. In this case the column(s) of the 1^{st} dimension is/are used and all of the detectors are available. All other paths are omitted for clarity.

FIG. 4A to E are results of a HPLC experiment of rituximab. The chromatogram is showing the UV detector response vs. retention time. FIG. 4B to F are screen shots of the official DLS software. It allows setting the intensity thresholds and analyzing the results. Spectrum in FIG. 4B shows the result of dynamic light scattering (DLS) experiment in flow mode. It comprises both intensity and Z-average versus retention volume. The highlighted area shows the peak of rituximab. FIG. 4C to E show the DLS results from batch mode. FIG. 4F is a result of rituximab zeta potential measurement.

FIG. 5A to E are results of a HPLC experiment of trastuzumab. The chromatogram is showing the UV detector response vs. retention time. FIG. 5B to F are screen shots of the official DLS software. It allows setting the intensity thresholds and analyzing the results. Spectrum in FIG. 5B shows the result of dynamic light scattering (DLS) experiment in flow mode. It comprises both intensity and Z-average versus retention volume. The highlighted area shows the peak of trastuzumab. FIG. 5C to E show the DLS results from batch mode. FIG. 5F is a result of trastuzumab zeta potential measurement.

FIG. 6 is a part of FIG. 1 when the first valve is in Position A and the second valve was changed to Position B. All non-used paths are omitted for clarity.

FIG. 7 is illustrating the case when the first valve moves to Position B, but the second valve does not. All paths which are not used omitted for clarity.

FIG. 8 is a graphical representation of a two-dimensional liquid chromatography system, where both valves are in Position B. The rest of paths are missing for clarity.

FIG. 9A to F show the results of two-dimensional separation of drug-loaded nanoparticles (NPs). The chromatogram is showing the UV detector response vs. retention time. FIG. 9B to F are screen shots of the official DLS software. It allows setting the intensity thresholds and analyzing the results. Spectrum in FIG. 9B shows the result of dynamic light scattering (DLS) experiment in flow mode. It comprises both intensity and Z-average versus retention volume. The highlighted area shows the peak of NPs. FIG. 9C to E show the DLS results from batch mode. FIG. 9F is a result of NPs zeta potential measurement.

FIG. 10 is showing the separation efficiency of two-dimensional liquid chromatography system. The sample is a solution mixture made from poly(γ-glutamic acid), caffeine, (±)-propanolol and thiourea.

FIG. 11 is showing the chromatogram of the SPE separation of drug-loaded nanoparticles and the free drug with the UV detector response vs. retention time.

FIG. 12 is showing the determination of the size of the NP with DLS in flow mode.

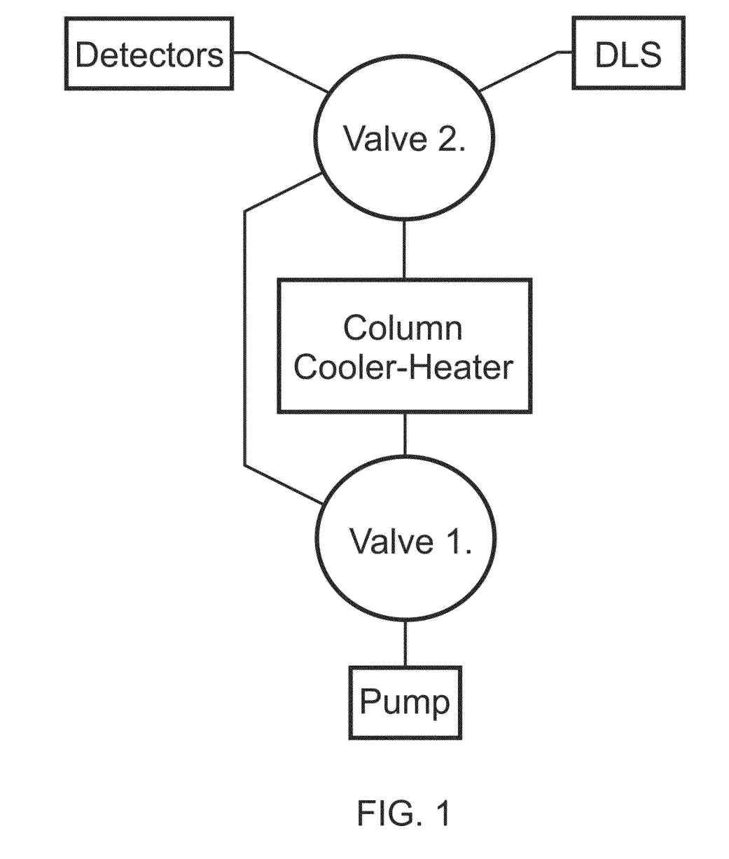

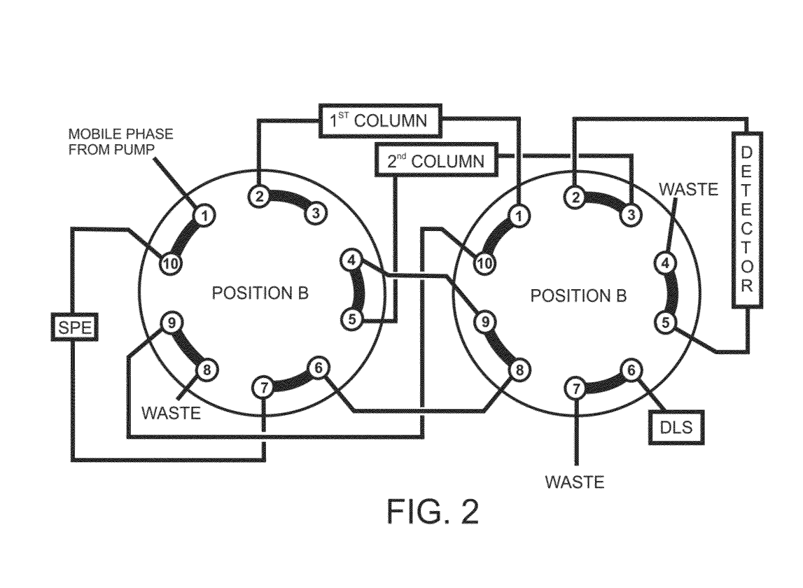

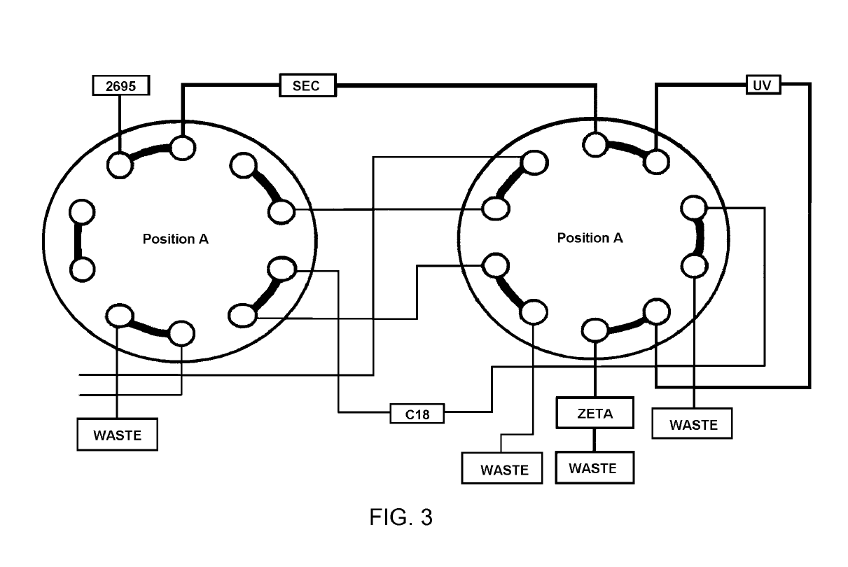

### DETAILED DESCRIPTION OF THE INVENTION

In the present invention, apparatus and method are disclosed for characterization of modified polymers, macromolecules, proteins, antigens, antibodies or nanoparticles. The method and apparatus is also described in further details below with reference to the figures, in which the similar items are numbered the same in the several figures.

The multi-dimensional liquid chromatography system in this present invention comprises two liquid chromatography systems in one, using two independently working switching valves. Our invention therefore relates to a method and an apparatus for the determination of impurity profile of nanodrugs in a two-dimensional liquid chromatography system. Nanodrugs can be modified polymers, macromolecules, proteins, antigens, antibodies or nanoparticles. The method and comprises:

a) injecting of a sample into the mobile phase of the first dimension which is generally adapted for size exclusion chromatography or gel permeation chromatography;
b) chromatographically separating of at least one sample component of the injected sample from other sample components in the first dimension;
c) collecting of the separated compounds in the first dimension with small molecular weight/particle size on at least one solid phase extraction (SPE) column;
d) eluting the adsorbed compounds from an SPE column with the second dimension mobile phase to the second dimension, what is generally adapted for high performance liquid chromatography;
e) chromatographically analysing of the component or separating of each component from others with baseline separation for quantitative determination;
where the connections between the first dimension, the SPE subdimension, the second dimension and detectors are created with two individually working switching valves.

In one embodiment the two-dimensional liquid chromatography systems comprises two or more flow-through detector for consecutive detection of separated subcomponents.

In another embodiment the first dimension of the two-dimensional liquid chromatography systems comprises two or more size exclusion chromatography columns.

In another embodiment the second dimension of the two-dimensional liquid chromatography systems comprises two or more liquid chromatography columns.

In another embodiment the first and the second dimensions are directly connected without solid phase extraction column.

In another embodiment the connections between dimensions and columns are solved with three or more individually working switching valves.

In another embodiment the method further comprises detecting of the first dimension separated components in the first dimension mobile phase eluent using at least one flow-through detector.

In another embodiment the detection of second dimension separated components is carried out using flow-through detector, mass detector or both.

In another embodiment the detection of first dimension separated components is carried out using at least one flow-through detector and a light scattering detector (e.g. evaporative LSD, dynamic LSD).

In another embodiment the first dimension is adapted for field-flow fractionation (FFF), asymmetric flow field-flow fractionation (AF4) or sedimentation field-flow fractionation (SFFF).

In another embodiment the second dimension of two-dimensional liquid chromatography system is a high performance liquid chromatography system adapted for mobile phase compositional gradient elution chromatography.

In another embodiment the second dimension of two-dimensional liquid chromatography system is a high performance liquid chromatography system adapted for temperature gradient elution chromatography.

In another embodiment the second dimension of two-dimensional liquid chromatography system is a high performance liquid chromatography system adapted for reverse phase chromatography.

In another embodiment the second dimension of two-dimensional liquid chromatography system is a high performance liquid chromatography system adapted for normal phase chromatography.

In another embodiment the second dimension of two-dimensional liquid chromatography system is a high performance liquid chromatography system adapted for adsorption chromatography.

In another embodiment the second dimension of two-dimensional liquid chromatography system is a high performance liquid chromatography system adapted for hydrophilic interaction liquid chromatography (HILIC).

In another embodiment the second dimension of two-dimensional liquid chromatography system is a high performance liquid chromatography system adapted for ion chromatography.

In another embodiment the second dimension of two-dimensional liquid chromatography system is a high performance liquid chromatography system adapted for affinity chromatography.

Accordingly, the subject matter of the present invention is summarized as follows:

1. A method for the characterization of organic materials and/or the quantitative determination of their impurity profile, comprising the steps of
a) performing of at least one size exclusion chromatography (SEC) or gel permeation chromatography in case of non-aqueous samples (GPC) to the complete molecular weight analysis of the organic materials, and to separate small molecules from big molecules, or different sorts of oligomers from each other;
b) optionally using of solid phase extraction (SPE) column(s) to collect small molecules, wash off or change solvent, or minimize broadening of their chromatographic peaks;
c) separating and characterizing small molecules by at least one high-performance liquid chromatography (HPLC);
to achieve the analysis of the average molecular weight and particle size distribution of said organic material.
2. In one embodiment of the method, the size of the organic material used is in the nanometric level.
3. In one embodiment of the method, the organic material used is selected from the group of drug-modified polymers, macromolecules, proteins, antigens, antibodies or organic nanoparticles.
4. In one embodiment of the method
a) two or more size exclusion chromatography columns are used; and/or
b) two or more liquid chromatography columns are used; and/or
c) no solid phase extraction column is used.
5. In one embodiment of the method, said method comprises the steps of
a) injecting a sample into the mobile phase of at least one device that has been adapted for size exclusion chromatography (SEC) or gel permeation chromatography (GPC);
b) chromatographically separating at least one sample component of the injected sample from other sample components in the first dimension;
c) collecting of the separated compounds in the first dimension with small molecular weight/particle size on at least one solid phase extraction (SPE) column;
d) eluting the adsorbed compounds from said SPE column with the mobile phase of a device that has been adapted for high performance liquid chromatography (HPLC);
e) chromatographically analyzing of each component or separating of each component from the others with baseline separation for quantitative determination.
6. In one embodiment of the method, the detection of the HPLC separated components is carried out using flow-through detector, mass detector or both.
7. In one embodiment of the method, the detection of the SEC/GPC separated components is carried out using at least one flow-through detector and a light scattering detector (LSD), preferably evaporative LSD or dynamic LSD.
8. In one embodiment of the method, the detection by the SEC/GPC is adapted for field-flow fractionation (FFF), asymmetric flow field-flow fractionation (AF4) or sedimentation field-flow fractionation (SFFF).
9. In one embodiment of the method, the high performance liquid chromatography system is
a) adapted for mobile phase compositional gradient elution chromatography; or
b) adapted for temperature gradient elution chromatography; or
c) adapted for reverse phase chromatography; or
d) adapted for normal phase chromatography; or
e) adapted for adsorption chromatography; or
f) adapted for hydrophilic interaction liquid chromatography (HILIC); or
g) adapted for ion chromatography; or
h) adapted for affinity chromatography.
10. Furthermore, the invention relates to a chromatographic system for the characterization of organic materials and/or the quantitative determination of their impurity profile comprising
a) at least one size exclusion chromatographic (SEC) device or gel permeation chromatographic (GPC) device;
b) optionally at least one solid phase extraction (SPE) device;
c) at least one high-performance liquid chromatography (HPLC)
d) at least one switching valve for switching between the SEC column, HPLC column, and SPE column or SPE-HPLC columns;
e) optionally at least one switching valve for directing the analyte to chromatographic detectors and for forming connections between columns;
f) optionally one or more chromatographic detector(s).
11. In one embodiment of the system, the SPE, the HPLC and the detectors are configured with two individually working switching valves.
12. In one embodiment of the system, said system comprises two or more flow-through detector for consecutive detection of the separated subcomponents.
13. In one embodiment of the system, the SPE device comprises two or more size exclusion chromatography columns; and/or the HPLC device comprises two or more liquid chromatography columns.
14. In one embodiment of the system, the connections between the columns are configured with three or more individually working switching valves.

### Example No 1

### Two-Dimensional Separation and Determination of Poly-γ-Glutamic Acid (PGA), Caffeine, Thiourea and (±)-Propanolol Mix Solution

This example demonstrates the effectiveness of the two-dimensional liquid chromatography system. The analysis was performed on a HPLC system (Waters e2695 Separations Module) equipped with an Ultrahydrogel 500 column (Waters, 7.8×300 mm, 10 μm), an Oasis HLB online column (Waters, 4.6×20 mm, 5 μm), an XBridge BEH C₁₈ column (Waters, 4.6×250 mm, 3.5 μm) and a UV/Vis detector (Waters 2489 UV/Vis detector). Briefly, 100 μL of the mix solution was injected to the mobile phase of the first dimension, which was made from high purity water (Millipore RiOs-DI 3, R≧18 MΩ) and contained 137 mM NaCl, 2.7 mM KCl, 10 mM Na₂HPO₄ and 2 mM KH₂PO₄. This buffer is also known as Phosphate Buffered Saline (PBS). The pH of the solution was set to pH=7.40. The mixture was chromatographically separated in the first dimension SEC column using isocratic elution. The flow rate was set to 0.80 mL/min and columns were maintained at 30° C. The first dimension mobile phase eluent coming off the SEC column was diverted switching the second valve to Position B, after the PGA peak appeared in the chromatogram. It resulted that the first dimension mobile phase was flowing through both SEC and SPE column. The caffeine, thiourea and (±)-propanolol were adsorbed by SPE column after they eluted from the size exclusion chromatography column. Then the first valve was switched to Position B so the flow path was going through both SPE and HPLC column. All of small molecules which were adsorbed on the SPE column were eluted then chromatographically separated in the second dimension HPLC column having separation media effective for reverse-phase separation. The second dimension mobile phase was 10 mM KH₂PO₄, pH=2.30 and acetonitrile, the separation was carried out using gradient elution with flow rate of 0.80 mL/min, and the column was maintained at 30° C.

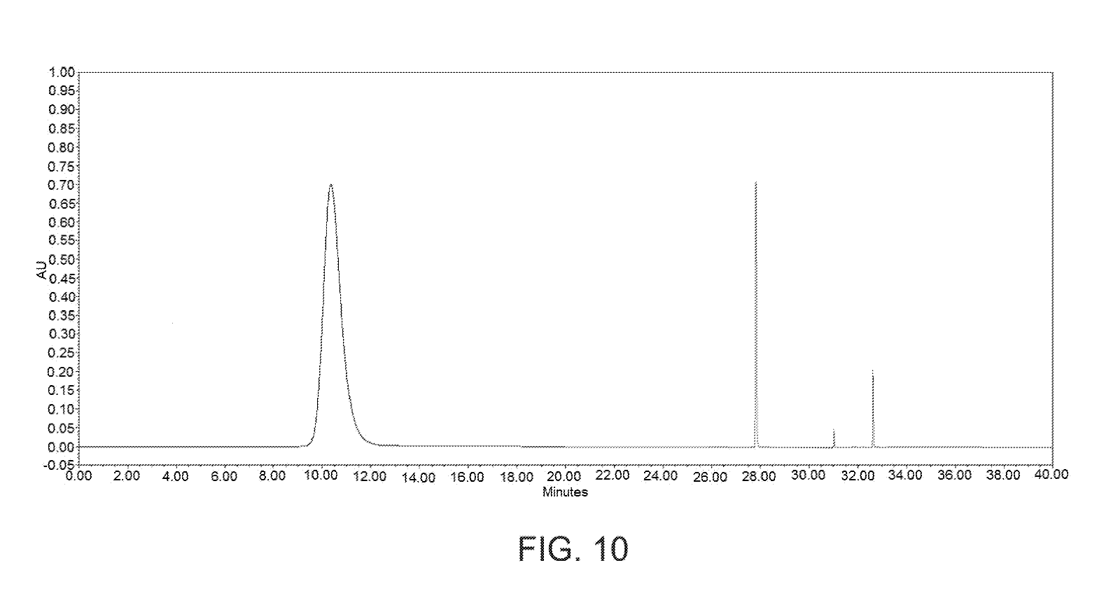

Before this experiment the size exclusion chromatography column was calibrated using a set of poly(acrylic acid) standards to determine the average molecular weight of PGA. FIG. 10 is a chromatogram showing detector response vs. retention time and it also demonstrates that the two-dimensional liquid chromatography system is a powerful tool for the separation of small molecules from each other and from big molecule(s).

### Example No 2

### Characterization and Determination of Impurity Profile of Drug-Loaded Nanoparticles (NPs)

This example demonstrates a two-dimensional liquid chromatography technique as applied for determining the impurity profile of a nanodrug. The characterization of nanoparticles was carried out with a HPLC system (Waters e2695 Separations Module) equipped with Ultrahydrogel 2000 column (Waters, 7.8×300 mm, 12 μm), an Oasis HLB online column (Waters, 4.6×20 mm, 5 μm), an XBridge BEH C₁₈ column (Waters, 4.6×250 mm, 3.5 μm), a UV/Vis detector (Waters 2489 UV/Vis detector) and a DLS detector (Malvern Zetasizer Nano ZS). The two-dimensional liquid chromatography system comprising a first dimension size exclusion chromatography (SEC) subsystem and a second dimension HPLC subsystem adapted for reverse-phase compositional gradient elution chromatography. The connection between the first and the second dimension is provided by a SPE column. Briefly, 50 μL of the mix solution was injected to the mobile phase of the first dimension. The operational protocols and conditions were substantially the same as described in EXAMPLE NO 1.

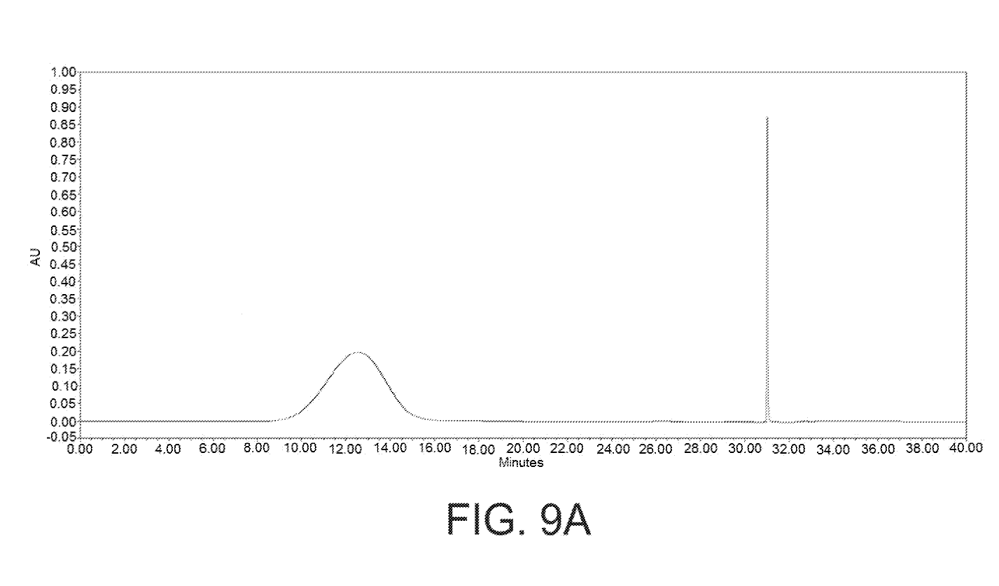

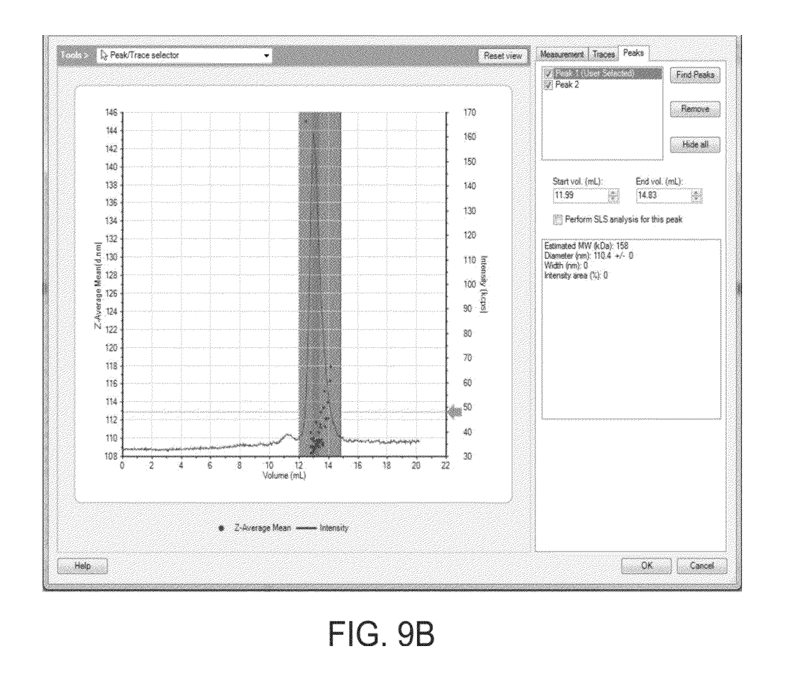

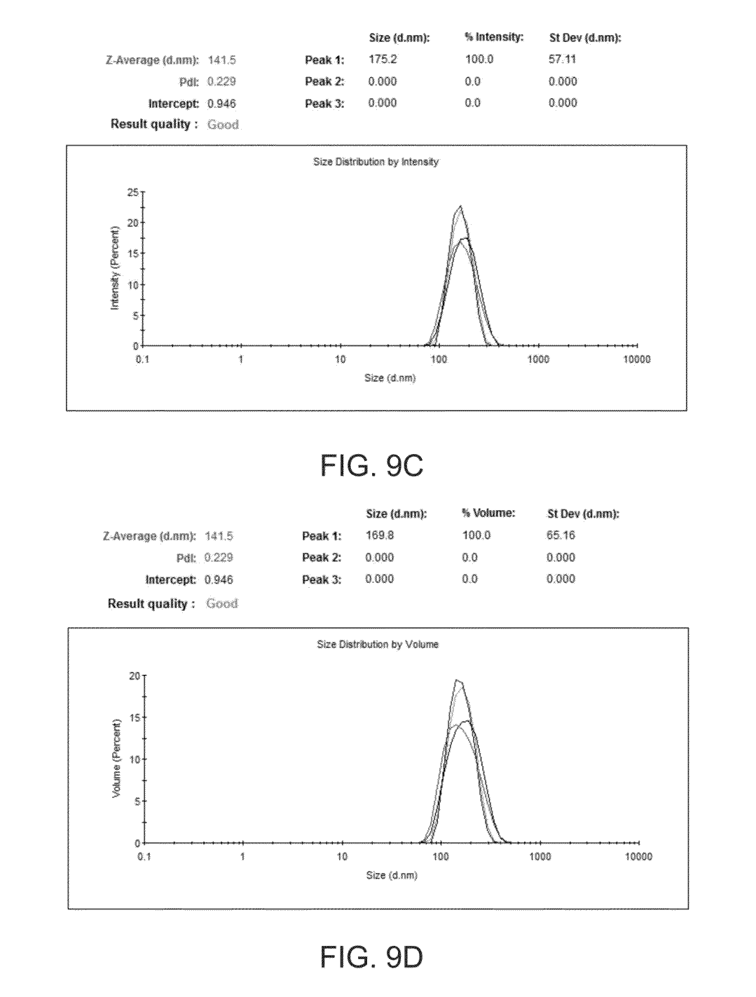

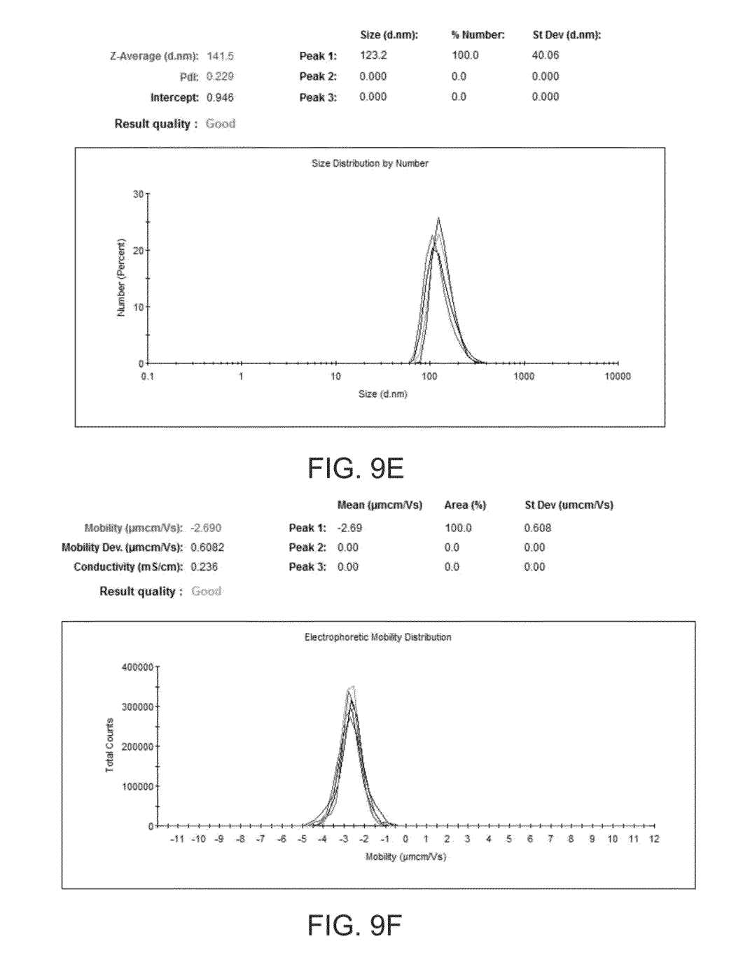

The results—shown in FIG. 9A to F—demonstrates that the two-dimensional liquid chromatography system provides substantial resolution of NPs and the drug modifier. The result in FIG. 9A shows the chromatogram of NPs and the drug modifier from UV detector (retention time versus UV/Vis detector response). FIG. 9B to F are screen shots of the original software of DLS detector. In FIG. 9B it can be seen that the detector monitored the intensity of backscattered light (continuous plot) and the average particle size (Z-average) in the passing solution (dots). For the evaluation of result the intensity thresholds can be set. The spectrum comprised both intensity and Z-average versus retention volume. The highlighted area indicates the specific volumes of mobile phase which contain trastuzumab. Note that the DLS detector was not working under the whole experiment to maximize the lifetime of the He/Ne laser. It can be started directly from the HPLC software during the separation measurement. In this experiment the start command was sent at 4.5 min, what is approximately the total exclusion time of SEC column at this flow rate.

For the best comparison the average size of trastuzumab was measured in batch mode with DLS detector. FIG. 9C to E show the size distribution of trastuzumab by intensity, volume and number, respectively. FIG. 9F shows the result of zeta potential measurement.

### Example No 3

### Characterization of Monoclonal Antibody

### Rituximab

This example demonstrates the efficiency of two-dimensional liquid chromatography system for the characterization of a monoclonal antibody (mAb). It was already presented in the two former examples that the system is not just functional, but highly efficient. Since the rituximab was purchased in a highly pure form, using of a two-dimensional system in these cases had become redundant. Therefore, in this example the first dimension was only used for characterizing the monoclonal antibody.

The experiment was carried out with a HPLC system (Waters e2695 Separations Module) equipped with an Ultrahydrogel Linear column (Waters, 7.8×300 mm, 10 μm), a UV/Vis detector (Waters 2489 UV/Vis detector) and a Dynamic Light Scattering (DLS) detector (Malvern Zetasizer Nano ZS). The flow rate was set to 0.80 mL/min using isocratic elution and both column and DLS detector were maintained at 30° C. Briefly, 20 μL of rituximab solution were injected to the mobile phase of the SEC column, which was made from high purity water (Millipore RiOs-DI 3, R≧18 MΩ) and contained 20 mM arginin and 30 mM Na₂HPO₄. The pH was set to 7.40 using concentrated o-phosphoric acid.

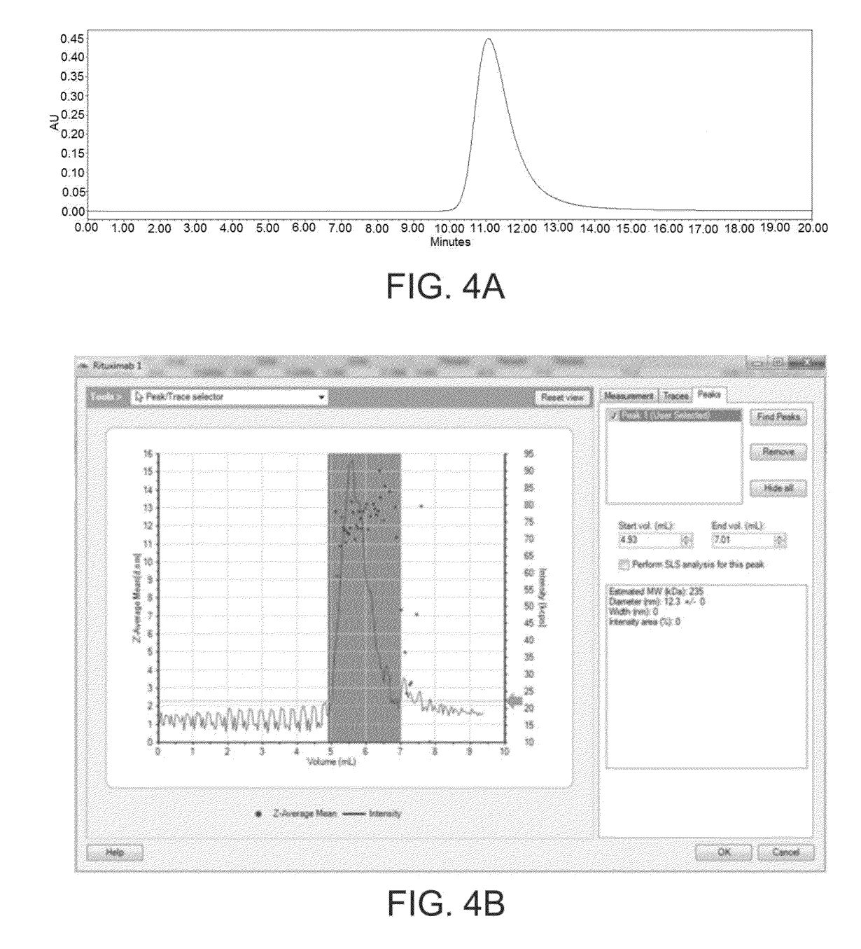

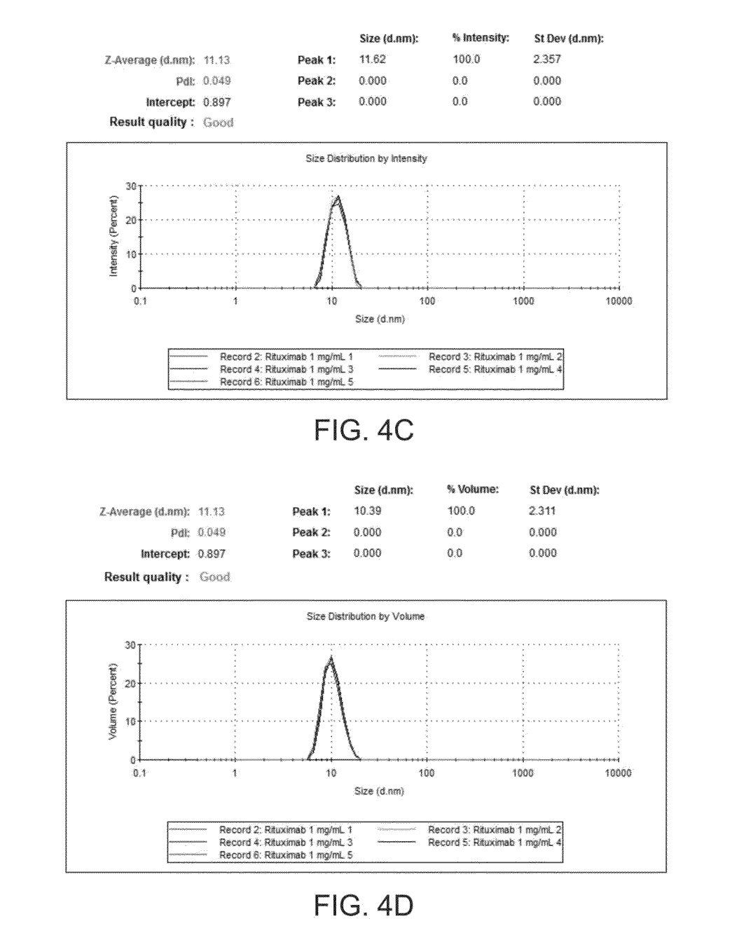

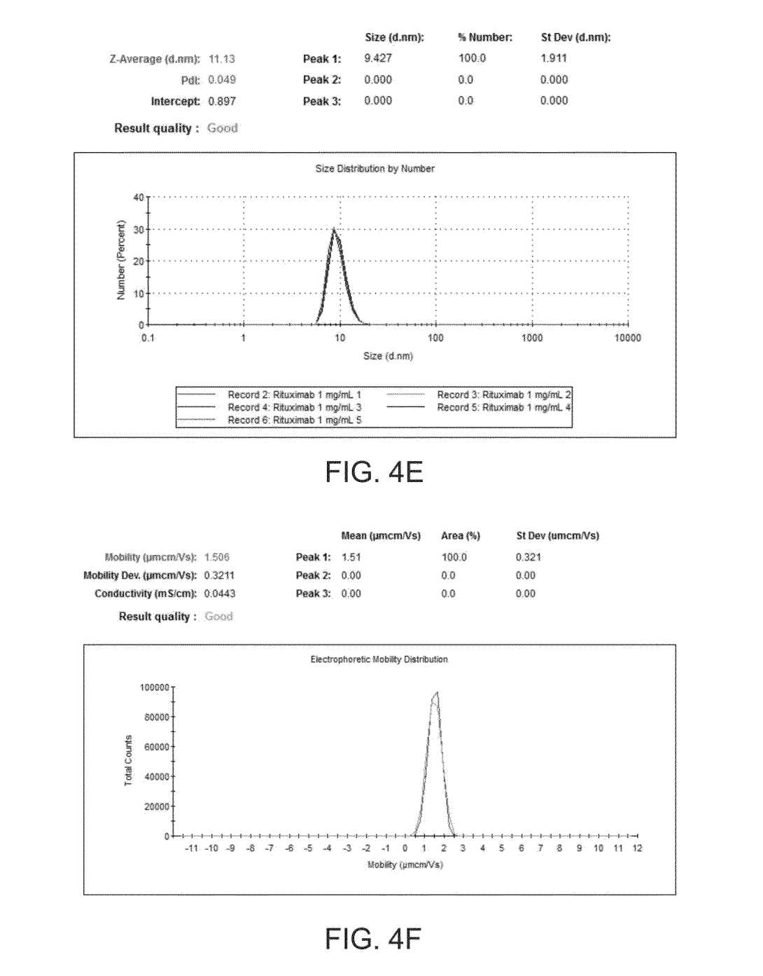

The result in FIG. 4A shows the chromatogram of rituximab from UV detector (retention time versus UV/Vis detector response). FIGS. 4A and B show the results of the chromatographic experiment of rituximab. FIG. 4B to F are screen shots of the original software of DLS detector. In FIG. 4B it can be seen that the detector monitored the intensity of backscattered light (continuous plot) and the average particle size (Z-average) in the passing solution (dots). For the evaluation of result the intensity thresholds can be set. The spectrum are comprised both intensity and Z-average versus retention volume. The highlighted area indicates the specific volumes of the mobile phase, which contain rituximab. Note that the DLS detector was not working under the whole experiment to maximize the lifetime of the He/Ne laser. It can be started directly from the HPLC software during the separation measurement. In this experiment the start command was sent at 4.5 min, what is approximately the total exclusion time of SEC column at this flow rate.

For the best comparison the average size of rituximab was measured in batch mode with DLS detector. FIG. 4C to E show the size distribution of rituximab by intensity, volume and number, respectively. FIG. 4F shows the result of zeta potential measurement.

### Example No 4

### Characterization of Monoclonal Antibody Trastuzumab

This example demonstrates the efficiency of two-dimensional liquid chromatography system for the characterization of a monoclonal antibody (mAb). It was already presented in the two former examples that the system is not just functional, but highly efficient. Since the trastuzumab was purchased in a highly pure form, using of a two-dimensional system in these cases had become redundant. Therefore, in this example the first dimension was only used for characterizing the monoclonal antibody.

The experiment was carried out with a HPLC system (Waters e2695 Separations Module) equipped with an Ultrahydrogel Linear column (Waters, 7.8×300 mm, 10 μm), a UV/Vis detector (Waters 2489 UV/Vis detector) and a Dynamic Light Scattering (DLS) detector (Malvern Zetasizer Nano ZS). The flow rate was set to 0.80 mL/min using isocratic elution and both column and DLS detector were maintained at 30° C. Briefly, 20 μL of trastuzumab solution were injected to the mobile phase of the SEC column, which was made from high purity water (Millipore RiOs-DI 3, R≧18 MΩ) and contained 20 mM arginin and 30 mM Na₂HPO₄. The pH was set to 7.40 using concentrated o-phosphoric acid.

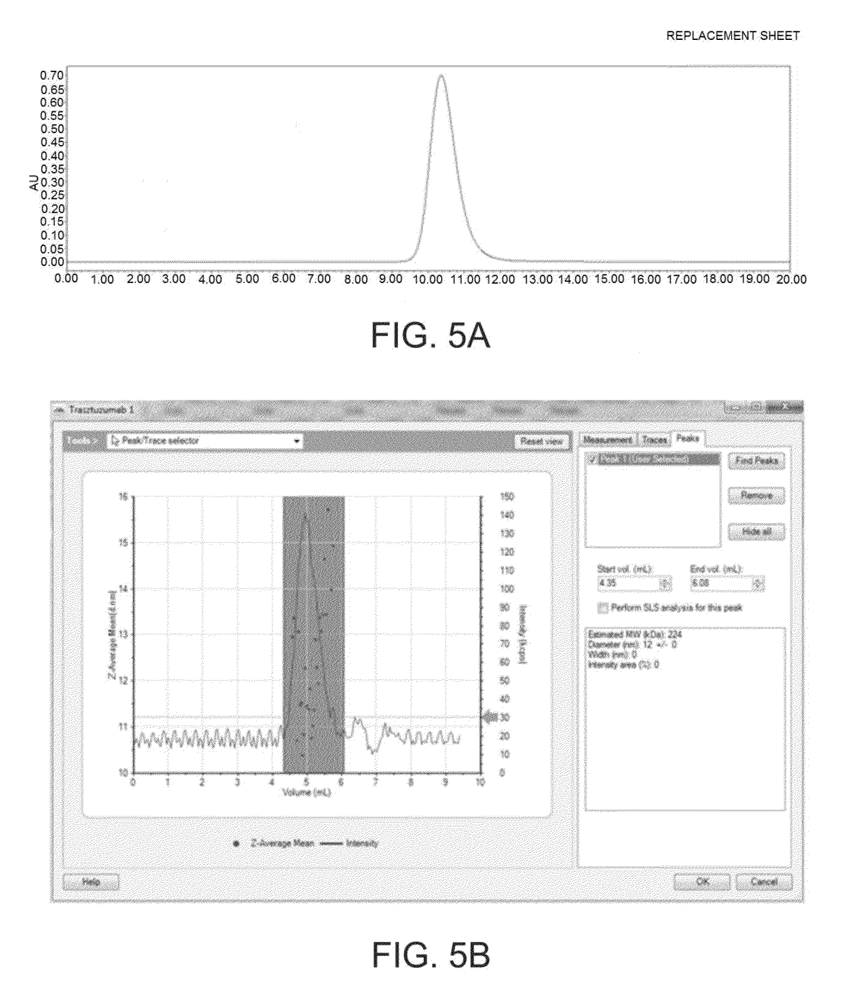

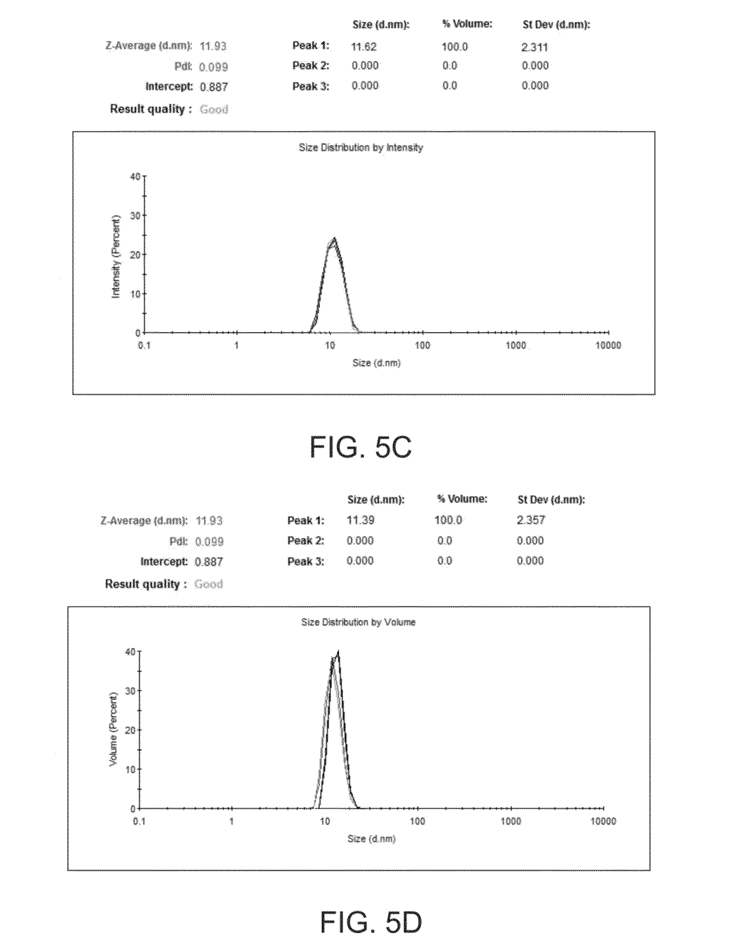

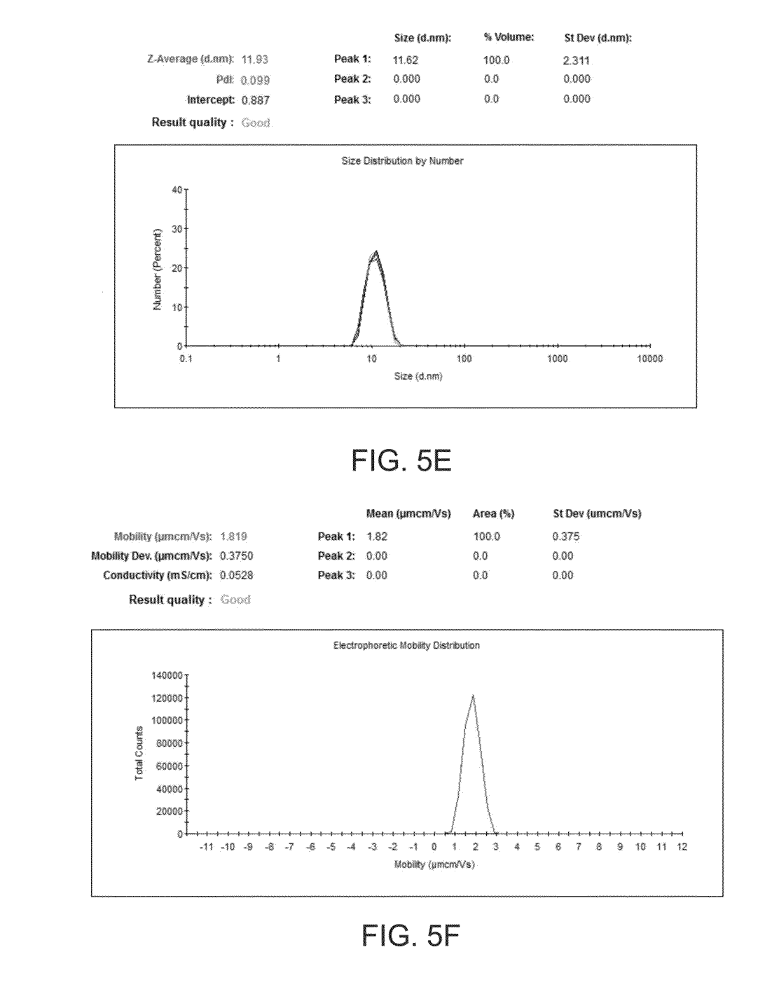

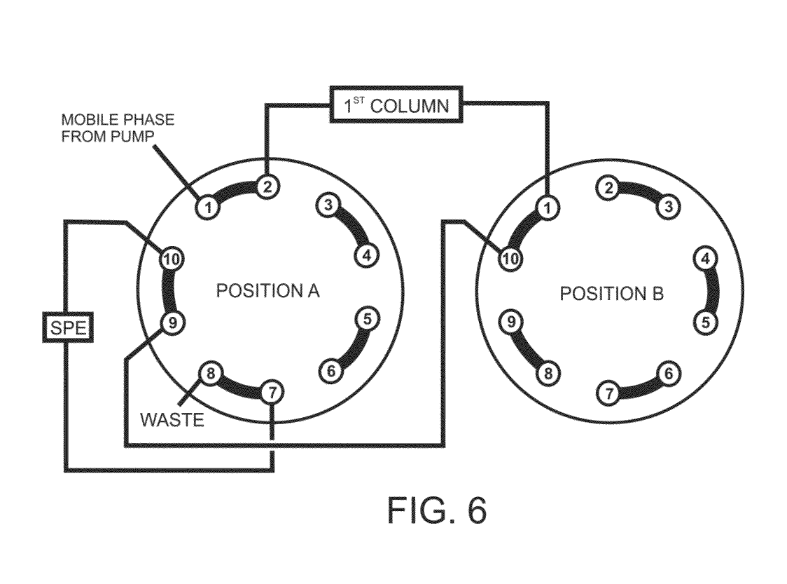

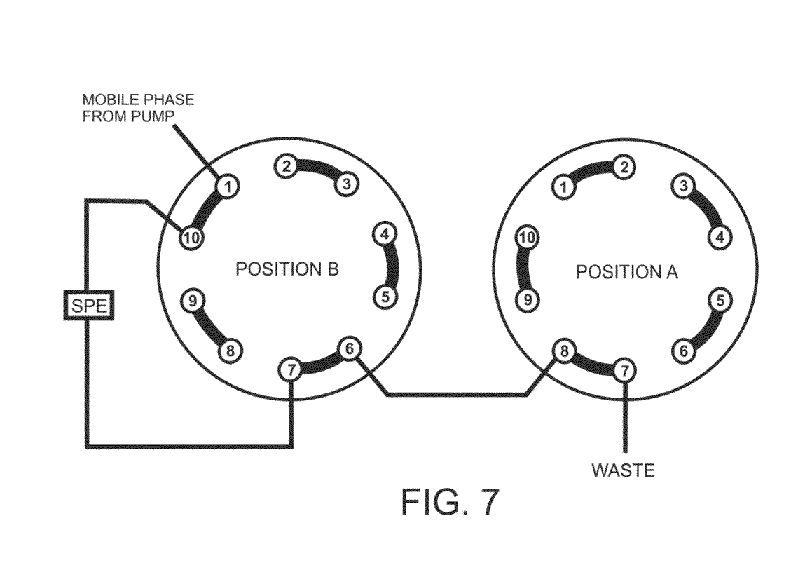

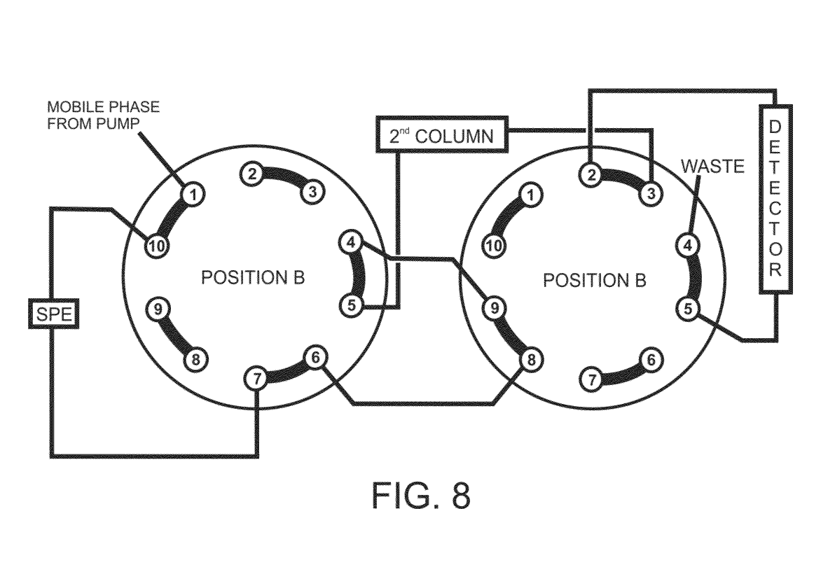

The result in FIG. 5A shows the chromatogram of trastuzumab from UV detector (retention time versus UV/Vis detector response). FIGS. 5A and B show the results of the chromatographic experiment of trastuzumab. FIG. 5B to F are screen shots of the original software of DLS detector. In FIG. 5B it can be seen that the detector monitored the intensity of backscattered light (continuous plot) and the average particle size (Z-average) in the passing solution (dots). For the evaluation of result the intensity thresholds can be set. The spectrum comprised both intensity and Z-average versus retention volume. The highlighted area indicates the specific volumes of mobile phase which contain trastuzumab. Note that the DLS detector was not working under the whole experiment to maximize the lifetime of the He/Ne laser. It can be started directly from the HPLC software during the separation measurement. In this experiment the start command was sent at 4.5 min, what is approximately the total exclusion time of SEC column at this flow rate.

For the best comparison the average size of trastuzumab was measured in batch mode with DLS detector. FIG. 5C to E show the size distribution of trastuzumab by intensity, volume and number, respectively. FIG. 5F shows the result of zeta potential measurement.

### Example No 5

### Quantitative and Qualitative Study of Drug-Loaded Nanoparticles

This example demonstrates the efficiency of two-dimensional liquid chromatography system for the characterization of drug concentration determination from drug-loaded NP. It was already presented that the system is not just functional, but highly efficient.

In this example the first dimension was used for collect the small Mw drug from the NP and quantitative determination of the drug concentration happen. In the second dimension with DLS, determination of the properties of the NPs.

The experiment was carried out with a HPLC system (Waters e2695 Separations Module) equipped with an Oasis HLB online column (Waters, 4.6×20 mm, 5 μm), a UV/Vis detector (Waters 2489 UV/Vis detector), detected on the adsorption maximum of the drug and Dynamic Light Scattering (DLS) detector (Malvern Zetasizer Nano ZS). The flow rate was set to 0.50 mL/min using gradient elution and both equipment were maintained at 30° C. Briefly, 20 μL of drug-loaded NP solution were injected to the mobile phase of the SPE column, which was made from high purity water (Millipore RiOs-DI 3, R≧18 MΩ) and contained 10 mM KH₂PO₄. The pH was set to 2.60 using concentrated o-phosphoric acid. The first and second valves are in Position A. The mobile phase going through the online extraction column (SPE) can collect the free drug or it can liberate when it is ionically bonded. Then the second valve was pulse and the DLS starting measure in flow mode.

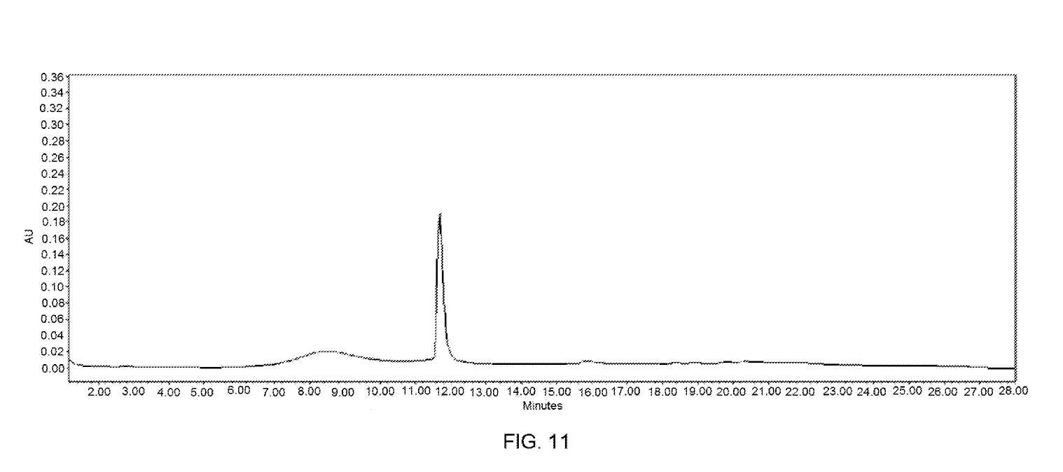

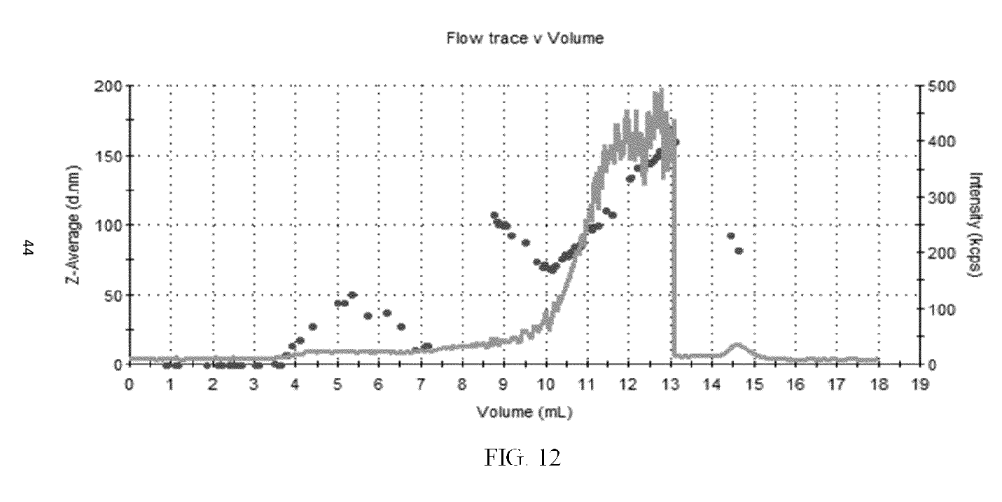

The result in FIG. 11. shows the chromatogram of drug-loaded nanoparticle from UV detector (retention time versus UV/Vis detector response). It can be seen that the detector monitored the intensity of NP and the free drug (continuous plot) at the same time which allow to determination the concentration of loaded drug. After the SPE separation the DLS can determinate the size of the NP. (FIG. 12.)

### REFERENCE CITED

### U.S. Patent Documents

| | | |
|---|---|---|
| 4,816,226 | March 1989 | Jordan et al. |
| 4,982,597 A | January 1191 | Berger |
| 5,738,783 A | April 1998 | Shirota et al. |
| 5,741,709 | April 1998 | Hsu |
| 6,063,283 A | May 2000 | Shirota et al. |
| 6,175,409 B1 | January 2001 | Nielsen et al. |
| 6,296,771 B1 | October 2001 | Miroslav |
| 6,345,528 B2 | February 2002 | Petro et al. |
| 6,406,632 B1 | May 2002 | Safir et al. |
| 6,461,515 B1 | October 2002 | Safir et al. |
| 6,475,391 B2 | November 2002 | Safir et al. |
| 6,726,843 B2 | April 2004 | Petro et al. |
| 6,776,902 B2 | August 2004 | Petro |
| 6,855,258 B2 | February 2005 | Petro et al. |
| 6,866,786 B2 | March 2005 | Petro et al. |
| 7,507,337 B2 | March 2009 | Petro et al. |

### Other Publications

Striegel A. M., Yau W. W., Kirkland J. J., Bly D.: Modern Size-Exclusion Liquid Chromatography: Practice of Gel Permeation and Gel Filtration Chromatography, 2009, 2^{nd} edition, Wiley, N.J.
Wang S., Li J., Shi X., Qiao L., Lu X., Xu G.: A Novel Stopped-Flow Two-Dimensional Liquid Chromatography-Mass Spectrometry Method for Lipid Analysis, J. Chromatogr. A, 2013, 1321, 65-72.
Kirkland J. J., Glajch J. L.: Optimization of Mobile Phases for Multisolvent Gradient Elution Liquid Chromatography, J. Chromatogr. A, 1983, 255, 27-39.
Larmann J. P., DeStefano J. J., Goldberg A. P., Stout R. W.: Separation of Macromolecules by Reverse-Phase High-Performance Liquid Chromatography: Pore-Size and Surface-Area effects for Polystyrene Samples of Varying Molecular Weight, J. Chromatogr. A, 1983, 255, 163-189.
Guiochon G., Beaver L. A., Gonnord M. F., Siouffi A. M., Zakaria M.: Theoretical Investigation of the Potentialities of the Use of a Multidimensional Column in Chromatography, J. Chromatogr. A, 1983, 255, 415-437.
Two-Dimensional Separations: Concept and Promise, Anal. Chem., 1984, 56, 1258A-1270A. Bushey M. M., Jorgenson J. W.: Automated Instrumentation for Comprehensive Two-dimensional High-Performance Liquid Chromatography of Proteins, Anal. Chem., 1990, 62, 161-167.
Horváth K., Fairchild J. N., Guiochon G.: Generation and Limitations of Peak Capacity in Online Two-Dimensional Liquid Chromatography, Anal. Chem., 2009, 81, 3879-3888.
Horie K., Kimura H., Ikegami T., Iwatsuka A., Saad N., Fiehn O., Tanaka N.: Calculating Optimal Modulation Periods to Maximize the Peak Capacity in Two-Dimensional HPLC, Anal. Chem., 2007, 79, 3764-3770.
Schlummer M., Brandl F., Mäurer A., van Eldik R.: Analysis of Flame Retardant Additives in Polymer Fractions of Waste of Electric and Electronic Equipment (WEEE) by Means of HPLC-UV/MS and GPC-HPLC-UV, J. Chromatogr. A, 2005, 1064, 39-51.
Giddings J. C.: Sample Dimensionality: A Predict of Order-Disorder in Component Peak Distribution in Multidimensional Separation, J. Chromatogr. A, 1995, 703, 3-15.
Hogendoorn E. A., van Zoonen P.: Coupled-Column Reverse-Phase Liquid Chromatography in Environmental Analysis, J. Chromatogr. A, 1995, 703, 149-166.
van Asten A. C., van Dam R. J., Kok W. T., Tijssen R., Poppe H.: Determination of the Compositional Heterogeneity of Polydisperse Polymer Samples by the coupling of Size-Exclusion Chromatography and Thermal Field-Flow Fractionation, J. Chromatogr. A, 1995, 703, 245-263.
Opiteck G. J., Jorgenson J. W., Anderegg R. J.: Two-Dimensional SEC/RPLC Coupled to Mass Spectrometry for the Analysis of Peptides, Anal. Chem., 1997, 69, 2283-2291.
Gilar M., Fridrich J., Schure M. R., Jaworski A.: Comparison of Orthogonality Estimation Methods for the Two-Dimensional Separations of Peptides, Anal. Chem., 2012, 84, 8722-8732.
Nerín C., Domeño C.: Determination of Polyaromatic Hydrocarbons and Some Related Compounds in Industrial Waste Oils by GPC-HPLC-UV, Analyst, 1999, 124, 67-70.
Gurjanov O. P., Ibragimova N. N., Gnezdilov O. I., Gorshkova T. A.: Polysaccharides, Tightly Bound to Cellulose in Cell Wall of Flax Bast Fibre: Isolation and Identification, Carbohyd. Polym., 2008, 72, 719-729.
Zhang C., Zhang H., Yang J., Liu Z.: Study on Depolymerisation of Poly(trimethylene terephthalate) in Supercritical Methanol by GPC-HPLC-IR, Polym. Degrad. Stabil., 2004, 86, 461-466.
Barth H. G., Boyes B. E., Jackson C.: Size-Exclusion Chromatography and Related Techniques, Anal. Chem., 1998, 70, 251-278.
D'Attoma A., Heinisch S.: On-line Comprehensive Two Dimensional Separations of Charged Compounds Using Reverse-Phase High Performance Liquid Chromatography and Hydrophilic Interaction Chromatography. Part II: Application to the Separation of Peptides, J. Chromatogr. A, 2013, 1306, 27-36.
Ren Q., Wu C., Zhang J.: Use of On-line Stop-flow Heart-cutting Two-Dimensional High Performance Liquid Chromatography for Simultaneous Determination of 12 Major Constituents in Tartary Buckwheat, J. Chromatogr. A, 2013, 1304, 257-262.
Wu Q., Wu D., Shen Z., Duan C., Guan Y.: Quantification of Endogeneous Brassinosteroids in Plant by On-line Two-Dimensional Microscale Solid Phase Extraction-On Column Derivatization Coupled with High Performance Liquid Chromatography-Tandem Mass Spectrometry, J. Chromatogr. A, 2013, 1297, 56-63.
Kittlaus S., Schimanke J., Kempe G., Speer K.: Development and Validation of an Efficient Automated Method for the Analysis of 300 Pesticides in Foods Using Two-Dimensional Liquid Chromatography-Tandem Mass Spectrometry, J. Chromatogr. A, 2013, 1283, 98-109.
Ginzburg A., Macko T., Malz F., Schroers M., Troetsch-Schaller I., Strittmatter J., Brüll R.: Characterization of Functionalized Polyolefins by High-Temperature Two-Dimensional Liquid Chromatography, J. Chromatogr. A, 2013, 1285, 40-47.
Malik M. I., Harding G. W., Grabowsky M. E., Pasch H.: Two-Dimensional Liquid Chromatography of Polystyrene-Polyethylene Oxide Block Copolymers, J. Chromatogr. A, 2013, 1244, 77-87.
Duarte R. M. B. O., Barros A. C., Duarte A. C.: Resolving the Chemical Heterogeneity of Natural Organic Matter: New Insights from Comprehensive Two-Dimensional Liquid Chromatography, J. Chromatogr. A, 2012, 1249, 138-146.
Lee D., Miller M. D., Meunier D. M., Lyons J. W., Bonner J. M., Pell R. J., Shan C. L. P., Huang T.: Development of High Temperature Comprehensive Two-Dimensional Liquid Chromatography Hyphenated with Infrared and Light Scattering Detectors for Characterization of Chemical Composition and Molecular Weight Heterogeneities in Polyolefin Copolymers, J. Chromatogr. A, 2011, 1218, 7173-7179.
Kaklamanos G., Theodoridis G., Dabalis T.: Gel Permeation Chromatography Clean-up for the Determination of Gestagens in Kidney Fat by Liquid Chromatography-Tandem Mass Spectrometry and Validation According to 2002/657/EC, J. Chromatogr. A, 2009, 1216, 8067-8071.
Rimkus G. G., Rummler M., Nausch I.: Gel Permeation Chromatography-High Performance Liquid Chromatography Combination as an Automated Clean-up Technique for the Multiresidue Analysis of Fats, J. Chromatogr. A, 1996, 737, 9-14.
López-Barajas M., López-Tamames E., Buxaderas S.: Improved Size-Exclusion High-Performance Liquid Chromatographic Method for the Simple Analysis of Grape Juice and Wine Polysaccharides, J. Chromatogr. A, 1998, 823, 339-347.
Reichenbach S. E.: Quantification in Comprehensive Two-Dimensional Liquid Chromatography, Anal. Chem., 2009, 81, 5099-5101.
Murphy R. E., Schure M. R., Foley J. P.: Effect of Sampling Rate on Resolution in Comprehensive Two-Dimensional Liquid Chromatography, Anal. Chem., 1998, 70, 1585-1594.
Marchetti N., Fairchild J. N., Guiochon G.: Comprehensive Off-Line, Two-Dimensional Liquid Chromatography. Application to the Separation of Peptide Digests, Anal. Chem., 2008, 80, 2756-2767.
Dugo P., Favoino O., Luppino R., Dugo G., Mondello L.: Comprehensive Two-Dimensional Normal-Phase (Adsorption)-Reversed-Phase Liquid Chromatography, Anal. Chem., 2004, 76, 2525-2530.
Eeltink S., Dolman S., Vivo-Truyols G., Schoenmakers P., Swart R., Ursem M., Desmet G.: Selection of Column Dimensions and Gradient Conditions to Maximize the Peak-Production Rate in Comprehensive Off-Line Two-Dimensional Liquid Chromatography Using Monolithic Columns, Anal. Chem., 2010, 82, 7015-7020.
Maiko K., Hehn M., Hiller W., Pasch H.: Comprehensive Two-Dimensional Liquid Chromatography of Stereoregular Poly(Methyl Methacrylates) for Tacticity and Molar Mass Analysis, Anal. Chem., 2013, 85, 9793-9798.
Porter S. E. G., Stoll D. R., Rutan S. C., Carr P. W., Cohen J. D.: Analysis of Four-Way Two-Dimensional Liquid Chromatography-Diode Array Data: Application to Metabolomics, Anal. Chem., 2006, 78, 5559-5569.
Bushey M. M., Jorgenson J. W.: Automated Instrumentation for Comprehensive Two-Dimensional High-Performance Liquid Chromatography of Proteins, Anal. Chem., 1990, 62, 161-167.
Uliyanchenko E., Cools P. J. C. H., van der Wal S., Schoenmakers P. J.: Comprehensive Two-Dimensional Ultrahigh-Pressure Liquid Chromatography for Separations of Polymers, Anal. Chem., 2012, 84, 7802-7809.
Xu Y., Mehl J. T., Bakhtiar R., Woolf E. J.: Immunoaffinity Purification Using Anti-PEG Antibody Followed by Two-Dimensional Liquid Chromatography/Tandem Mass Spectrometry for the Quantification of a PEGylated Therapeutic Peptide in Human Plasma, Anal. Chem., 2010, 82, 6877-6886.
Pomazal K., Prohaska C., Steffan I., Reich G., Huber J. F. K.: Determination of Cu, Fe, Mn, and Zn in Blood Fractions by SEC-HPLC-ICP-AES Coupling, Analyst, 1994, 124, 657-663.
Gonzalez-Fernández M., García-Sevillano M. A., Jara-Biedma R., García-Barrera T., Vioque A., López-Barea J., Pueyo C., Gómez-Ariza J. L.: Size Characterization of Metal Species in Liver and Brain From Free-Living (Mus Spretus) and Laboratory (Mus Musculus) Mice by SEC-ICP-MS: Application to Environmental Contamination Assessment, J. Anal. At. Spectrom., 2011, 26, 141-149.

1. A method for the characterization of organic materials and/or the quantitative determination of their impurity profile, comprising the steps of
a) performing of at least one size exclusion chromatography (SEC) or gel permeation chromatography in case of non-aqueous samples (GPC) to the complete molecular weight analysis of the organic materials, and to separate small molecules from big molecules, or different sorts of oligomers from each other;
b) optionally using of solid phase extraction (SPE) column(s) to collect small molecules, wash off or change solvent, or minimize broadening of their chromatographic peaks;
c) separating and characterizing small molecules by at least one high-performance liquid chromatography (HPLC);
to achieve the analysis of the average molecular weight and particle size distribution of said organic material.

2. The method as claimed in claim 1, wherein the size of the organic material used is in the nanometric level.

3. The method as claimed in claim 1, wherein the organic material used is selected from the group of drug-modified polymers, macromolecules, proteins, antigens, antibodies or organic nanoparticles.

4. The method as claimed in claim 1, wherein
a) two or more size exclusion chromatography columns are used; and/or
b) two or more liquid chromatography columns are used; and/or
c) no solid phase extraction column is used.

5. A method as claimed in claim 1, comprising the steps of
a) injecting a sample into the mobile phase of at least one device that has been adapted for size exclusion chromatography (SEC) or gel permeation chromatography (GPC);
b) chromatographically separating at least one sample component of the injected sample from other sample components in the first dimension;
c) collecting of the separated compounds in the first dimension with small molecular weight/particle size on at least one solid phase extraction (SPE) column;
d) eluting the adsorbed compounds from said SPE column with the mobile phase of a device that has been adapted for high performance liquid chromatography (HPLC);
e) chromatographically analyzing of each component or separating of each component from the others with baseline separation for quantitative determination.

6. A method as claimed in claim 1, wherein the detection of the HPLC separated components is carried out using flow-through detector, mass detector or both.

7. A method as claimed in claim 1, wherein the detection of the SEC/GPC separated components is carried out using at least one flow-through detector and a light scattering detector (LSD), preferably evaporative LSD or dynamic LSD.

8. A method as claimed in claim 1, wherein the detection by the SEC/GPC is adapted for field-flow fractionation (FFF), asymmetric flow field-flow fractionation (AF4) or sedimentation field-flow fractionation (SFFF).

9. A method as claimed in claim 1, wherein the high performance liquid chromatography system is
a) adapted for mobile phase compositional gradient elution chromatography; or
b) adapted for temperature gradient elution chromatography; or
c) adapted for reverse phase chromatography; or
d) adapted for normal phase chromatography; or
e) adapted for adsorption chromatography; or
f) adapted for hydrophilic interaction liquid chromatography (HILIC); or
g) adapted for ion chromatography; or
h) adapted for affinity chromatography.

10. A chromatographic system for the characterization of organic materials and/or the quantitative determination of their impurity profile comprising
a) at least one size exclusion chromatographic (SEC) device or gel permeation chromatographic (GPC) device;
b) optionally at least one solid phase extraction (SPE) device;
c) at least one high-performance liquid chromatography (HPLC)
d) at least one switching valve for switching between the SEC column, HPLC column, and SPE column or SPE-HPLC columns;
e) optionally at least one switching valve for directing the analyte to chromatographic detectors and for forming connections between columns;
f) optionally one or more chromatographic detector(s).

11. The chromatographic system as claimed in claim 10, wherein the SPE the HPLC and the detectors are configured with two individually working switching valves.

12. The chromatographic system as claimed in claim 10, which comprises two or more flow-through detector for consecutive detection of the separated subcomponents.

13. The chromatographic system as claimed in claim 10, wherein the SPE device comprises two or more size exclusion chromatography columns; and/or the HPLC device comprises two or more liquid chromatography columns.

14. The chromatographic system as claimed in claim 10, wherein the connections between the columns are configured with three or more individually working switching valves.
